(19) United States
(12) Patent Application Publication
(10) Pub. No.: US 2016/0104918 A1
(43) Pub. Date: Apr. 14, 2016

(54) GEL POLYMER ELECTROLYTE AND LITHIUM ION BATTERIES EMPLOYING THE GEL POLYMER ELECTROLYTE

(71) Applicants: Joyce WANG, Suzhou, Jiangsu (CN); BASF CORPORATION, Florham Park, NJ (US)

(72) Inventor: Joyce Wang, Suzhou City (CN)

(21) Appl. No.: 14/893,695

(22) PCT Filed: May 24, 2013
(86) PCT No.: PCT/CN2013/076210

§ 371 Date: Nov. 24, 2015

(51) Int. Cl. H01M 10/0565; H01M 10/0525

(52) U.S. Cl. CPC H01M 10/0565; H01M 10/0525; H01M 2300/0025

(57) ABSTRACT

The invention relates to a composition for preparing a gel polymer electrolyte, comprising: (1) a prepolymer; (2) a lithium salt; (3) an organic solvent; (4) a cross-linking agent; (5) an initiator; (6) optionally a monomer; and (7) optionally an additive; wherein the prepolymer comprises polyamides, polyimides and their combination. The invention also relates to a gel polymer electrolyte obtained by polymerization, especially in-situ polymerization of the composition and lithium-ion batteries employing the gelpolymer electrolyte, and a method of preparing the ge polymer electrolyte.

### FIELD OF THE INVENTION

The invention relates to a composition for preparing a gel polymer electrolyte, a gel polymer electrolyte obtained from the composition, lithium-ion batteries employing the gel polymer electrolyte, and a method of preparing the gel polymer electrolyte.

### DESCRIPTION OF RELATED ARTS

Recently, lithium ion batteries using a polymer electrolyte have attracted ever-increasing interests, both in academia and in industry. The polymer electrolyte can be classified into two categories with one being completely-solid polymer electrolyte and the other being gel-type polymer electrolyte.

U.S. Pat. No. 8,318,342 B2 teaches an all solid-state polymer battery that uses a dry polymer electrolyte including a specific ethylene glycol ether, a polymer containing electron-donating oxygen atoms in the skeleton and a lithium salt. It's full solid but has a very low conductivity of 1.0-3.0×10⁻⁵ S/cm.

As the conductivity of the completely-solid polymer electrolyte is very low (<10⁻⁵ S/cm), the gel-type polymer electrolyte is the candidate of choice for this polymer electrolyte technique.

According to the arts, there are mainly two ways to prepare gel polymer electrolyte. The first way is to put a special membrane coated with a polymer matrix into a battery, followed by injecting a traditional liquid electrolyte solution into the battery to finally obtain the gel polymer electrolyte. The second way is to make the gel polymer electrolyte by in-situ polymerization reaction in a battery, where raw materials including monomers or pre-polymers, cross-linking agents, initiators, organic solvents, lithium salts are mixed together to prepare the gel polymer electrolyte.

About the first way, the study of the polymer matrix is concentrated on polyvinylidene fluoride-hexafluoropropylene (PVDF-HFP). U.S. Pat. No. 7,651,820 B2 presents a method to make a gel electrolyte by using polyvinylidene fluoride copolymerized with hexafluoropropylene, a nonaqueous electrolytic solution, and dimethyl carbonate as a diluent solvent. Although the gel electrolyte completely covered the active material portion on the electrode and the layer was uniform, the thickness of the full battery increased, and the vaporization of the diluent solvent caused the wasting of raw material and air pollution.

U.S. Pat. No. 7,129,005 B2 discloses a polymer electrolyte, which includes a polyimide, at least one lithium salt. This polymer electrolyte does not dissolve in an organic electrolyte solution at room temperature or at high temperatures, so it will not escape and cause injury under extreme conditions. Although the polymer electrolyte can operate over a broad temperature range, the conductivity of the polymer electrolyte is less than 4.2×10⁻⁴S/cm.

The second way is simple and cost-effective, so it's more acceptable. It's reported that after in-situ polymerization reaction of the raw materials in a battery, the types of the formed polymer matrix include polyethyleneglycol dimethylether, polyethyleneglycol diethylether, polyethyleneglycol dimethacrylate, polyethyleneglycol diacrylate, polypropyleneglycol dimethacrylate, polypropyleneglycol diacrylate, polyvinylidenefluoride, polyurethane, polyethylene oxide, polyacrylamide and combinations thereof. EP2400589A1 discloses a new method of preparing gel electrolyte through thermal polymerization of monomers, liquid electrolyte and initiator. The monomers comprise carbonates, ethers and ketones containing an unsaturated carbon-carbon bond. This polymeric gel electrolyte has good adhesiveness to electrodes, and has good ionic conductivity; however, its polymeric matrix belongs to polypropylene and its derivatives, or polycarbonate and its derivatives. They are not stable at high temperature neither in carbonate or other organic solvents for long time.

Thus, there is still a need to provide a gel polymer electrolyte having a higher conductivity without leakage and lithium-ion batteries having good capacity retention.

### SUMMARY OF THE INVENTION

For the purposes of the invention, the invention provides a composition for preparing a gel polymer electrolyte comprising:

(1) a prepolymer;

(2) a lithium salt;

(3) an organic solvent;

(4) a cross-linking agent;

(5) an initiator;

(6) optionally a monomer; and

(7) optionally an additive;

wherein the prepolymer comprises polyamides, polyimides and their combinations.

The invention also provides a gel polymer electrolyte obtained by polymerization, especially in-situ polymerization of a composition comprising:

(1) a prepolymer;

(2) a lithium salt;

(3) an organic solvent;

(4) a cross-linking agent;

(5) an initiator;

(6) optionally a monomer; and

(7) optionally an additive;

wherein the prepolymer comprises polyamides, polyimides and their combinations.

The invention also provides a method of preparing the gel polymer electrolyte, comprising the steps of:

(1) providing a composition comprising components (1) to (5) and optionally components (6) and (7) mentioned above;

(2) performing polymerization, especially in-situ polymerization of the composition.

The invention further provides a gel polymer electrolyte battery comprising:

an anode,

a cathode;

a separator; and

a gel polymer electrolyte prepared above.

Surprisingly, the inventors found that the object of the invention can be achieved by polymerization, especially in-situ polymerization of polyamides and/or polyimides as prepolymers.

### Embodiments of the Invention

In one embodiment of the present invention, the invention provides a composition for preparing a gel polymer electrolyte especially by in-situ polymerization comprising:

(1) a prepolymer;

(2) a lithium salt;

(3) an organic solvent;

(4) a cross-linking agent;

(5) an initiator;

(6) optionally a monomer; and

(7) optionally an additive;

wherein the prepolymer comprises polyamides, polyimides and their combinations.

Preferably, the polyamides are one or more selected from the group consisting of polycaprolactam, polycapryllactam, polyphthalamide, poly terephthalamide, poly(hexamethylene sebacamide), polytrimethylhexamethyleneterephthalamide, poly(p-phenylene terephthalamide), poly(m-phenylene isophthalamide), poly(hexamethylene adipamide) and poly(p-benzamide).

Preferably, the polyimides are one or more selected from the group consisting of bismaleimide prepolymer, bismaleimide triazine resin, polyesterimide, ketone anhydride polyimide, polyetherimide, maleic anhydride polyimide, poly(pyromellitimido-1,4-phenylene), and polyarylene imide sulfide. In one preferred embodiment of the invention, the polyetherimide is elected from the group consisting of polyether polyimide, single ether polyimide and double ether polyimide.

In one embodiment of the present invention, the prepolymer can further comprise one or more selected from the group consisting of polycarbonates, polymethyl methacrylate, polyacrylamide, polyvinyl acetate, polyvinylidenefluoride, polyvinylidenefluoride-hexafluoropropylene copolymer, polyurethane, polyethylene oxide, polyethyleneglycol dimethylether, polyethyleneglycol diethylether, polyethyleneglycol dimethacrylate and polypropyleneglycol diacrylate.

Preferably, the prepolymer has a weight average molecular weight of 100 to 5,000, more preferably from 200 to 2000.

Preferably, the cross-linking agent is one or more selected from the group consisting of N,N′-methylenediacrylamide, ethylene glycol dimethacrylate, trimethylol propane trimethacrylate, trimethylolpropane triacrylate, tripropylene glycol diacrylate, tetraethoxysilane, tetramethoxysilane, trimethoxysilane and divinylbenzene.

Preferably, the initiator is one or more selected from the group consisting of dimethyl 2,2′-azobis(2-methylpropionate), azobisisobutyronitrile, azobisisoheptonitrile, dicumyl peroxide, di-tert-butyl peroxide, benzoyl peroxide, lauroyl peroxide and tert-butyl peroxy benzoate.

Preferably, the organic solvent is one or more selected from the group consisting of ethylene carbonate, propylene carbonate, dimethyl carbonate, diethyl carbonate, dipropyl carbonate, dibutyl carbonate, ethyl methyl carbonate, methyl propyl carbonate, butyl formate, 1,4-butanolide, 2-methyltetrahydrofuran, 1,2-dimethoxyethane, methyl acetate, methyl propionate, ethyl propionate, methyl butyrate, trifluoroethyl methacrylate, dimethyl sulfoxide, sulfolane, propanesultone, glycol sulfite and diglycol dimethyl ether.

Preferably, the lithium salt is one or more selected from the group consisting of LiClO₄, LiPF₆, LiBF4, LiBOB, LiODFB, LiTFSi, LiCF₃SO₃, LiN(CF₃SO₂)₂, LiB(C₂O₄)₂ and LiBF₂C₂O₄.

Preferably, the monomer is one or more selected from the group consisting of dimethyl cis-butenedioate, methyl acrylate, ethyl acrylate, 2-propenoic acid, methyl methacrylate, ethyl methacrylate, methallyl methacrylate, monomethyl maleate, dimethyl maleate, diethyl maleate, dibutyl maleate, diisooctyl maleate, diisopentyl maleate, N,N-dimethylacrylamide, acrylamide and methacrylamide.

Preferably, the additive is one or more selected from the group consisting of solid electrolyte interface forming improving agent, cathode protection agent, lithium salt stabilizer, overcharge protection agent, fire-retardant additive, Li deposition improving agent, ionic salvation enhance agent, Al corrosion inhibitor, wetting agent and viscosity diluter. More preferably, the additive is one or more selected from the group consisting of vinylene carbonate, vinyl ethylene carbonate, fluoroethylene carbonate, ethylene sulfite, 1,3-propane sultone, N,N-diethylamino trimethylsilane, tris(2,2,2-trifluoroethyl) phosphite, 1-methyl-2-pyrrolidinone, fluorinated carbamate, hexamethyl-phosphoramide, cyclohexyl benzene, biphenyl, hexamethoxycyclotriphosphazene, 2-methyltetrahydrofuran, tris(pentafluorophenyl) borane, trialkyl phosphate, ethylene sulfate, propylene sulfite, trimethylene sulfite, phenylacetone, 1,4-butane sultone, propane 1,2-cyclic suefate, propane 1,2-cyclic sulfite, diethyl (cyanomethyl) phosphate, N,N-dimethylformamide, methylene methanedisulfonate, tris(trimethylsilyl) phosphite, tris(trimethylsilyl) phosphate, tris(trimethylsilyl) borate, 1,3-butylene glycol sulfite, N,N′-dimethyl-trifluoroacetamide, 2,2-diphenyl propane, N,N′-dicyclohexyl carbodiimide, chloroethyleneglycol carbonate and 1,3-dioxolane,4,5-dichloro-2-oxo.

In one preferred embodiment of the present invention, the content of the prepolymer is 0.5%-30 wt %, the content of the lithium salt is 7.5-15.5 wt %, the content of the organic solvent is 70-99.34 wt %, the content of the cross-linking agent is 0.1-8 wt %, the content of the initiator is 0.01-5 wt %, the content of the monomer is 0-8 wt %, and the content of the additive is 0.1%-10 wt %, based on the total weight of the composition, and the sum of the percentage contents is 100 wt %.

In still one preferred embodiment of the present invention, the content of the prepolymer is 2.5%-15 wt %, the content of the lithium salt is 10.5-12.5 wt %, the content of the solvent is 85-90 wt %, the content of the cross-linking agent is 0.8-4 wt %, the content of the initiator is 0.1-1 wt %, the content of the monomer is 0.8-3.5 wt %, and the content of the additive is 0.2%-5 wt %, based on the total weight of the composition, and the sum of the percentage contents is 100 wt %.

The conductivity of the gel electrolyte is tested by electrochemical impedance spectroscopy (EIS) in passive stainless steel model test battery. Preferably, the gel polymer electrolyte has conductivity in the range from 3.5×10⁻³ to 6.9×10⁻³ S/cm.

In one embodiment of the present invention, the invention provides a method of preparing the gel polymer electrolyte, comprising the steps of:

(1) providing a composition comprising the components (1) to (5) and optionally components (6) and (7) mentioned above;

(2) performing polymerization, especially in-situ polymerization of the composition.

In the context of the present invention, the in-situ polymerization means that the polymerization is carried out in a lithium ion battery to be formed. Herein the transitional liquid electrolyte consists of organic solvents, lithium salts and optionally additives.

Preferably, the reaction temperature of the polymerization, especially in-situ polymerization is in the range of 20 to 100° C., more preferably 60 to 85° C. In one preferred embodiment of the present invention, the polymerization, especially in-situ polymerization is performed at ambient temperature for 12-24 h, and followed by at 60-85° C. for 12-48 h.

In one embodiment of the present invention, the invention provides a gel polymer electrolyte battery comprising:

an anode,

a cathode;

a separator; and

the gel polymer electrolyte prepared above.

In one embodiment of the present invention, the lithium ion battery is prepared as follows: anode preparation was as follows: 90 wt. % of graphite powder suspended in a solution of 10 wt. % of poly(vinylidene)fluoride (PVDF) in N-methyl-2-pyrrolidone was spread on the copper foil current collector, dried at 100° C. for 12 h, pressed at 100 kg/cm², then finally dried under vacuum at 85° C. for 48 h. LiCoO₂ cathode was made from 90 wt. % of LiCoO₂, 5 wt. % of acetylene black and 5 wt. % of PVDF. The preparation of the cathode was very similar to the method of anode preparation, but aluminum foil instead of copper foil was used for the cathode current collector. Separator was PP/PE composite film.

Preferably, the anode is one or more selected from the group consisting of natural graphite, artificial graphite, modified graphite, amorphous graphite, mesocarbon microbeads, Si-based materials, Sn-based materials, and Li₄Ti₅O₁₂.

Preferably, the cathode is one or more selected from the group consisting of LiCoO₂, LiNiO₂, LiNi_{1-(x+y)}CoₓM_{y}O₂ (M represents Mn or Al, 0≦x≦1, 0≦y≦1, 0≦x+y≦1), LiFePO₄, LiVPO₄, LiMnPO₄, LiFe_{1-a-b}VₐMn_{b}PO₄(0≦a≦1, 0≦a+b≦1, 0≦a+b≦1), Li₂FeSiO₄, Li₂MnSiO₄, and Li₂Fe_{z}Mn_{1-z}SiO₄(0<z<1).

Preferably, the separator is selected from the group consisting of polyethylene film, polypropylene film and their combination.

In the present invention, all shapes of lithium ion battery can be assembled by the electrodes, gel polymer electrolyte and separator above, like cylindrical Li-ion battery, prismatic Li-ion battery, soft-pack Li-ion battery and so on.

This gel polymer electrolyte can be used in lithium ion batteries for EV/HEV and digital products, etc.

The flexibility and leakage properties of the gel polymer are tested as follows: put a glass plate on the gel polymer electrolyte, and add a pressure of 150 g/cm² on the glass plate to observe the flexibility and leakage cases. After putting away the pressure and the glass plate, if the gels recovery immediately and completely, the flexibility is excellent. If the gels recovery slowly and completely, the flexibility is good. If the gels recovery incompletely, the flexibility is common. If the gels can't recovery or it's broken, the flexibility is poor.

The capacity retention performance of the lithium ion battery is tested by BK-6864AR/5 rechargeable battery Testing System (Guangzhou Blue-key Electronic Industry Co.Ltd, China).

All percentages are mentioned by weight unless otherwise indicated.

### EXAMPLES

The present invention is now further illustrated by reference to the following examples, however, the examples are used for the purpose of explanation and not intended to limit the scopes of the invention.

### Example 1

All the raw materials were dried, the test standards of the materials are: moisture content≦550 ppm, HF content≦100 ppm.

The liquid electrolyte solution (i.e. transitional liquid electrolyte) denoted as La was formulated as 1M LiPF₆ dissolved in a mixture of ethylene carbonate: ethyl methyl carbonate: diethyl carbonate=1:1:1 (by volume), wherein La also comprises 1 wt % of vinylene carbonate based on the weight of La.

The gel polymer electrolyte in example 1 was obtained from the following composition as follows:

La: 477 g

Poly(hexamethylene adipamide) (Mw=678.95 g/mol): 18.55 g

Divinylbenzene: 3.75 g

dimethyl 2,2′-azobis(2-methylpropionate): 0.7 g

The gel polymer electrolyte preparation: the upper materials were successively added and stirred for 30 minutes every time at ambient temperature, then the liquid mixture was respectively injected into a lithium ion battery to be formed, a passive stainless steel test battery, an aluminum plastic bag of the soft-pack lithium ion battery. All the processes were conducted in an inert atmosphere. The batteries were allowed to stand for 16-18 h after sealed, then was enhanced to 60° C. and stored for 24 h.

Preparation of test model battery for measuring the conductivity of the gel polymer electrolyte: the electrodes of the battery were passive stainless steel, and the surface area of the electrode was 1 cm², the distance between the two electrodes was 1 cm.

The gel polymer electrolyte from the aluminum plastic bag was put between two glasses, and then compressed to observe the flexibility and leakage case.

Lithium ion battery: anode preparation was as follows: 90 wt. % of graphite powder suspended in a solution of 10 wt. % of poly(vinylidene)fluoride (PVDF) in N-methyl-2-pyrrolidone was spread on the copper foil current collector, dried at 100° C. for 12 h, pressed at 100 kg/cm², then finally dried under vacuum at 85° C. for 48 h. LiCoO₂ cathode was made from 90 wt. % of LiCoO₂, 5 wt. % of acetylene black and 5 wt. % of PVDF. The preparation of the cathode was very similar to the method of anode preparation, but aluminum foil instead of copper foil was used for the cathode current collector. Separator was PP/PE composite film.

In the comparable example 1, the lithium ion battery was obtained by using La instead of the gel polymer electrolyte.

### Example 2

The liquid electrolyte solution denoted as Lb (i.e. transitional liquid electrolyte) was formulated as 1M LiPF₆ dissolved in a mixture of ethylene carbonate: ethyl methyl carbonate: diethyl carbonate=1:1:1 (by volume).

The gel polymer electrolyte in example 2 was obtained from the following composition as follows:

Lb: 477 g

polytrimethylhexamethyleneterephthalamide (Mw=615 g/mol): 18.55 g

Divinylbenzene: 3.75 g

dimethyl 2,2′-azobis(2-methylpropionate): 0.7 g

The gel polymer electrolyte was obtained by the same method as that of example 1.

In-situ thermal polymerization conditions: 65° C. for 36 h.

Test model battery was obtained by the same method as that of example 1.

Lithium ion battery was obtained by the same method as that of example 1.

### Example 3

The liquid electrolyte solution (i.e. transitional liquid electrolyte) denoted as Lc was formulated as 1M LiPF₆ dissolved in a mixture of ethylene carbonate: ethyl methyl carbonate: diethyl carbonate=1:1:1 (by volume), wherein Lc also comprises 3.5 wt % of propylene sulfite based on the weight of Lb.

The gel polymer electrolyte in example 3 was obtained from the following composition as follows:

Lc: 472 g

poly(p-phenylene terephthalamide) (Mw=822 g/mol): 8 g

polycarbonate (Mw=1025 g/mol): 5 g

polyesterimide(Mw=836 g/mol): 5 g

methyl methacrylate: 2.75 g

ethylene glycol dimethacrylate: 3.75 g

azobisisobutyronitrile: 3.5 g

Gel polymer electrolyte preparation: adding poly(p-phenylene terephthalamide) into Lb, and stirring for 90 minutes at 50° C. to disperse and dissolve it. Successively adding polycarbonate, polyesterimide, methyl methacrylate, ethylene glycol dimethacrylate and azobisisobutyronitrile after the liquid cooled to ambient temperature. Other processes were the same as example 1.

Test model battery was obtained by the same method as that of example 1.

Lithium ion battery was obtained by the same method as that of example 1.

### Example 4

A gel polymer electrolyte was obtained by the same method as that of example 3, except that polymethyl methacrylate (Mw=1257 g/mol) was used instead of polycarbonate.

In-situ thermal polymerization conditions: 70° C. for 36 h.

Test model battery was obtained by the same method as that of example 1.

Lithium ion battery was obtained by the same method as that of example 1, except that LiNi_{0.4}Mn_{0.4}Co_{0.2}O₂ was used instead of LiCoO₂.

In the comparable example 2, the lithium ion battery was obtained by using Lc instead of the gel polymer electrolyte.

### Example 5

A gel polymer electrolyte was obtained by the same method as that of example 3, except that bismaleimide prepolymer (Mw=717 g/mol) was used instead of polycarbonate.

In-situ thermal polymerization conditions: 70° C. for 36 h.

Test model battery was obtained by the same method as that of example 1.

Lithium ion battery was obtained by the same method as that of example 4.

### Example 6

A gel polymer electrolyte was obtained by the same method as that of example 4, except that polypyromelliticimide (Mw=1140 g/mol) was used instead of polycarbonate.

In-situ thermal polymerization conditions: 75° C. for 36 h.

Test model battery was obtained by the same method as that of example 1.

Lithium ion battery was obtained by the same method as that of example 4.

### Example 7

The liquid electrolyte solution (i.e. transitional liquid electrolyte) denoted as Ld was formulated as 1M LiPF₆ dissolved in a mixture of ethylene carbonate: ethyl methyl carbonate: diethyl carbonate=1:1:1 (by volume), wherein Ld also comprises 5 wt % of fluoroethylene carbonate based on the weight of Ld.

The gel polymer electrolyte in example 7 was obtained from the following composition as follows:

Ld: 473 g

poly(m-phenylene isophthalamide) (Mw=822 g/mol): 10 g,

polyvinylidenefluoride(Mw=273 g/mol): 5 g

Diethyl Maleate: 3.75 g,

trimethylol propane trimethacrylate: 3.75 g,

azobisisoheptonitrile: 4.5 g

Gel polymer electrolyte preparation: adding poly(m-phenylene isophthalamide) into Ld, stirring for 90 minutes at 50° C. to disperse and dissolve it, and the same treatment method to polyvinylidenefluoride was followed. Successively adding diethyl maleate, trimethylol propane trimethacrylate and azobisisoheptonitrile after the liquid cooled to ambient temperature. Other processes were the same as example 1.

Test model battery was obtained by the same method as that of example 1.

Lithium ion battery was obtained by the same method as that of example 1, except that LiMn₂O₄ was used instead of LiCoO₂.

In the comparable example 3, the lithium ion battery was obtained by using Ld instead of the gel polymer electrolyte.

### Example 8

A gel polymer electrolyte was obtained by the same method as that of example 7, except that polyacrylamide (Mw=618 g/mol) was used instead of polyvinylidenefluoride.

In-situ thermal polymerization conditions: 80° C. for 30 h.

Test model battery was obtained by the same method as that of example 1.

Lithium ion battery was obtained by the same method as that of example 7.

### Example 9

A gel polymer electrolyte was obtained by the same method as that of example 7, except that polypyromelliticimide (Mw=1140 g/mol) was used instead of polyvinylidenefluoride.

In-situ thermal polymerization conditions: 80° C. for 30 h.

Test model battery was obtained by the same method as that of example 1.

Lithium ion battery was obtained by the same method as that of example 7.

### Example 10

A gel polymer electrolyte was obtained by the same method as that of example 7, except that polyesterimide (Mw=348 g/mol) was used instead of polyvinylidenefluoride.

In-situ thermal polymerization conditions: 80° C. for 30 h.

Test model battery was obtained by the same method as that of example 1.

Lithium ion battery was obtained by the same method as that of example 7, except that LiFePO₄ was used instead of LiCoO₂.

In the comparable example 4, the LiFePO₄ battery was obtained by using Ld instead of the gel polymer electrolyte.

### Example 11

A gel polymer electrolyte was obtained by the same method as that of example 7, except that polyimide based on fluoroalkylene dianhydride (Mw=2904 g/mol) was used instead of polyvinylidenefluoride.

In-situ thermal polymerization conditions: 80° C. for 30 h.

Test model battery was obtained by the same method as that of example 1.

Lithium ion battery was obtained by the same method as that of example 10.

### Example 12

A gel polymer electrolyte was obtained by the same method as that of example 7, except that polyetherimide (Mw=3540 g/mol) was used to instead of polyvinylidenefluoride.

In-situ thermal polymerization conditions: 80° C. for 30 h.

Test model battery was obtained by the same method as that of example 1.

Lithium ion battery was obtained by the same method as that of example 10.

The physical properties of the gel polymer electrolytes produced from the above examples were listed in table 1:

TABLE 1
the physical properties of the gel polymer electrolytes

| samples | Ionic conductivity (S/cm) | flexibility | leakage |
|---|---|---|---|
| Example 1 | 6.82 × 10⁻³ | Excellent | x |
| example 2 | 6.18 × 10⁻³ | Excellent | x |
| example 3 | 5.93 × 10⁻³ | Excellent | x |
| example 4 | 5.75 × 10⁻³ | good | x |
| example 5 | 6.04 × 10⁻³ | Excellent | x |
| example 6 | 5.56 × 10⁻³ | good | x |
| example 7 | 4.38 × 10⁻³ | good | x |
| example 8 | 3.96 × 10⁻³ | good | x |
| example 9 | 3.54 × 10⁻³ | common | x |
| example 10 | 5.84 × 10⁻³ | good | x |
| example 11 | 5.69 × 10⁻³ | common | x |
| example 12 | 4.92 × 10⁻³ | common | x |

Notes:
x represent no leakage.

Table 1 shows that the gel polymer electrolytes of the present invention have higher conductivity and better flexibility, and have no leakage.

The performance of the lithium ion batteries produced by the above examples was listed in Table 2.

TABLE 2
the performances of the produced lithium ion batteries

| | | 25° C. | 45° C. |
|---|---|---|---|
| | −20° C. | 1CC1CD cycle | 1CC1CD cycle |
| | 0.3 Cdischarge | Capacity | Capacity |
| | Capacity | retention | retention |
| samples | retention | after 300 times | after 200 times |
| comparable | 80% | 85% | 80% |
| example 1 | | | |
| example1 | 82% | 86% | 83% |
| example 2 | 76% | 78% | 75% |
| example 3 | 65% | 74% | 73% |
| comparable | 68% | 83% | 75% |
| example 2 | | | |
| example 4 | 63% | 79% | 77% |
| example 5 | 67% | 85% | 78% |
| example 6 | 59% | 74% | 66% |
| comparable | 73% | 80% | 72% |
| example 3 | | | |
| example 7 | 74% | 78% | 73% |
| example 8 | 58% | 71% | 62% |
| example 9 | 56% | 65% | 59% |
| comparable | 65% | 94% | 91% |
| example 4 | | | |
| example 10 | 67% | 94% | 92% |
| example 11 | 59% | 86% | 83% |
| example 12 | 48% | 78% | 83% |

Notes:
1CC1CD represents the lithium ion battery charge and discharge at the current of 1 C.

Table 2 shows that the lithium ion batteries of the present invention have capacity retention similar to or even higher than that of the transitional liquid lithium ion batteries.

It will be apparent to those skilled in the art that various modifications and variations can be made in the present invention without departing from the scope or spirit of the invention. Thus, it is intended that the present invention cover such modifications and variations as come within the scope of the appended claims and their equivalents.

1. A composition for preparing a gel polymer electrolyte comprising:
(1) one or more prepolymers;
(2) one or more lithium salts;
(3) one or more organic solvents;
(4) one or more cross-linking agents;
(5) one or more initiators;
(6) optionally one or more monomers; and
(7) optionally one or more additives;
wherein the prepolymers comprise one or more polyamides.

2. The composition according to claim 1, wherein the prepolymers have a weight average molecular weight of 100 to 5,000 g/mol.

3. The composition according to claim 1, wherein the polyamides are selected from the group consisting of polycaprolactam, polycapryllactam, polyphthalamide, poly terephthalamide, poly(hexamethylene sebacamide), polytrimethylhexamethyleneterephthalamide, poly(p-phenylene terephthalamide), poly(m-phenylene isophthalamide), poly(hexamethylene adipamide) and poly(p-benzamide).

4. The composition according to claim 1, wherein the prepolymers further contain one or more polyimides selected from the group consisting of bismaleimide prepolymer, bismaleimide triazine resin, polyesterimide, ketone anhydride polyimide, polyetherimide, maleic anhydride polyimide, poly(pyromellitimido-1,4-phenylene) and polyarylene imide sulfide.

5. The composition according to claim 1, wherein the lithium salts are selected from the group consisting of LiClO₄, LiPF₆, LiBF₄, LiBOB, LiODFB, LiTFSi, LiCF₃SO₃, LiN(CF₃SO₂)₂, LiB(C₂O₄)₂ and LiBF₂C₂O₄.

6. The composition according to claim 1, wherein the organic solvents are selected from the group consisting of ethylene carbonate, propylene carbonate, dimethyl carbonate, diethyl carbonate, dipropyl carbonate, dibutyl carbonate, ethyl methyl carbonate, methyl propyl carbonate, butyl formate, 1,4-butanolide, 2-methyltetrahydrofuran, 1,2-dimethoxyethane, methyl acetate, methyl propionate, ethyl propionate, methyl butyrate, trifluoroethyl methacrylate, dimethyl sulfoxide, sulfolane, propanesultone, glycol sulfite and diglycol dimethyl ether.

7. The composition according to claim 1, wherein the cross-linking agents are selected from the group consisting of N,N′-methylenediacrylamide, ethylene glycol dimethacrylate, trimethylol propane trimethacrylate, trimethylolpropane triacrylate, tripropylene glycol diacrylate, tetraethoxysilane, tetramethoxysilane, trimethoxysilane and divinylbenzene.

8. The composition according to claim 1, wherein the initiators are selected from the group consisting of dimethyl 2,2′-azobis(2-methylpropionate), azobisisobutyronitrile, azobisisoheptonitrile, dicumyl peroxide, di-tert-butyl peroxide, benzoyl peroxide, lauroyl peroxide and tert-butyl peroxy benzoate.

9. The composition according to claim 1, wherein the monomers are selected from the group consisting of dimethyl cis-butenedioate, methyl acrylate, ethyl acrylate, 2-propenoic acid, methyl methacrylate, ethyl methacrylate, methallyl methacrylate, monomethyl maleate, dimethyl maleate, diethyl maleate, dibutyl maleate, diisooctyl maleate, diisopentyl maleate, N,N-dimethylacrylamide, acrylamide and methacrylamide.

10. The composition according to claim 1, wherein the additives are selected from the group consisting of solid electrolyte interface forming improving agent, cathode protection agent, lithium salt stabilizer, overcharge protection agent, fire-retardant additive, Li deposition improving agent, ionic salvation enhance agent, Al corrosion inhibitor, wetting agent and viscosity diluter.

11. The composition according to claim 1, wherein the content of the prepolymer is 0.5%-30 wt %, the content of the lithium salt is 7.5-15.5 wt %, the content of the organic solvent is 70-99.34 wt %, the content of the cross-linking agent is 0.1-8 wt %, the content of the initiator is 0.01-5 wt %, the content of the monomer is 0-8 wt % and the content of the additive is 0.1%-10 wt %, based on the total weight of the composition, where the sum of the percentage contents is 100 wt %.

12. The composition according to claim 1, wherein the prepolymer further comprises one or more selected from the group consisting of polycarbonates, polymethyl methacrylate, polyacrylamide, polyvinyl acetate, polyvinylidenefluoride, polyvinylidenefluoride- hexafluoropropylene copolymer, polyurethane, polyethylene oxide, polyethyleneglycol dimethylether, polyethyleneglycol diethylether, polyethyleneglycol dimethacrylate and polypropyleneglycol diacrylate.

13. A gel polymer electrolyte obtained by polymerization of the composition according to claim 1.

14. The gel polymer electrolyte according to claim 13 which has conductivity in the range from 3.5×10⁻³ to 6.9×10⁻³ S/cm.

15. A method of preparing the gel polymer electrolyte according to claim 13, comprising:
(1) providing a composition comprising components (1) to (5) and optionally components (6) and (7) and;
(2) performing polymerization of the composition.

16. The method according to claim 15, wherein the reaction temperature of the polymerization is in the range of 20 to 100° C.

17. A gel polymer electrolyte battery comprising:
an anode,
a cathode;
a separator; and
a gel polymer electrolyte according to claim 13.

18. The gel polymer electrolyte battery according to claim 17, wherein the anode is selected from the group consisting of natural graphite, artificial graphite, modified graphite, amorphous graphite, mesocarbon microbeads, Si-based materials, Sn-based materials and Li₄Ti₅O₁₂.

19. The gel polymer electrolyte battery according to claim 17, wherein the cathode is selected from the group consisting of LiCoO₂, LiNiO₂, LiNi_{1-(x+y)}CoₓM_{y}O₂ (M represents Mn or Al, 0≦x≦1, 0≦y≦1, 0≦x+y≦1), LiFePO₄, LiVPO₄, LiMnPO₄, LiFe_{1-a-b}VₐMn_{b}PO₄(0≦a≦1, 0≦b≦1, 0≦a+b≦1), Li₂FeSiO₄, Li₂MnSiO₄ and Li₂Fe_{z}Mn_{1-z}SiO₄(0<z<1).

20. The gel polymer electrolyte battery according to claim 17, wherein the separator is selected from the group consisting of polyethylene film, polypropylene film and their combination.

21. The composition according to claim 1, wherein the prepolymers have a weight average molecular weight of 200 to 2,000 g/mol.

22. The composition according to claim 1, wherein the content of the prepolymer is 2.5%-15 wt %, the content of the lithium salt is 10.5-12.5 wt %, the content of the solvent is 85-90 wt %, the content of the cross-linking agent is 0.8-4 wt %, the content of the initiator is 0.1-1 wt %, the content of the monomer is 0.8-3.5 wt % and the content of the additive is 0.2%-5 wt %, based on the total weight of the composition, where the sum of the percentage contents is 100 wt %.

23. The gel polymer electrolyte according to claim 13 obtained by in-situ polymerization.
